(19) United States
(12) Patent Application Publication
(10) Pub. No.: US 2008/0017577 A1
(43) Pub. Date: Jan. 24, 2008

(54) Membrane-based Double-layer Tube for Sample Collections

(75) Inventors: Jizu Yi, Bayside, NY (US); Fu Chung Lin, Ridgewood, NJ (US); Dimitrios Manoussakis, Wyckoff, NJ (US); Craig Gelfand, Jackson, NJ (US)

Correspondence Address: DAVID W. HIGHET, VP AND CHIEF IP COUNSEL;BECTON, DICKINSON AND COMPANY, 1 BECTON DRIVE, MC 110, FRANKLIN LAKES, NJ, 07417-1880, US

(73) Assignee: BECTON, DICKINSON AND COMPANY, Franklin Lakes, NJ (US)

(21) Appl. No.: 11/459,076

(22) Filed: Jul. 21, 2006

(51) Int. Cl. B01D 61/18

(52) U.S. Cl. 210/645

(57) ABSTRACT

The fluid sample collection device is adapted to collect and separate a fluid sample into constituent parts such as separating plasma or serum from a blood sample. The device includes an evacuated outer container and an inner container. The outer container has a first open end and a second closed end. A pierceable closure closes the first open end thereby defining a first interior chamber. The inner container is contained within the outer container and separates the first interior chamber into an upper chamber portion and lower chamber portion in fluid communication. The inner container defines a second interior chamber separated from the lower chamber portion through a porous membrane. A port is provided for placing the second interior chamber in fluid communication with the first interior chamber. Another aspect of the device relates to a method of using the device to separate plasma or serum from a blood sample.

### BACKGROUND OF THE INVENTION

1. Field of the Invention

The present invention relates to a fluid sample collection device and, more particularly, to a fluid sample collection device adapted to separate plasma or serum from a blood sample. More specifically, the present invention relates to an evacuated fluid sample collection device capable of separating plasma or serum from the cellular material in a blood sample through a porous filter also referred to as a membrane herein.

2. Description of Related Art

Plasma is the liquid portion of blood and is primarily comprised of water, proteins, glucose, amino acids, vitamins, inorganic salts, metabolites, and metabolic waste products. The generally solid portion of blood is comprised of a variety of cells including red cells, white cells, and platelets. Plasma is freely transferable with cells of the body. As a whole, plasma provides the medium to suspend white blood cells, red blood cells, and other cellular components for transport throughout a human or animal. If a plasma sample is desired, its separation from blood cells must occur well before blood coagulation. An anti-coagulation reagent may be added to a blood collection device to prevent coagulation. If blood is allowed to coagulate, the remaining liquid portion of the collected blood sample is called serum, which is devoid of some protein components of plasma. Separation of plasma/serum from blood cells is typically achieved by centrifugation.

Because plasma contains a rich source of components available for diagnostic analysis, medical devices have been devised for separating plasma from a whole blood sample. Several known blood collection devices are provided as evacuated multi-chamber devices that incorporate a filter or membrane that is used to remove or separate plasma from a collected blood sample. In some devices, the devices include a detachable chamber allowing a user to access the separated plasma specimen. Typically, in these known blood sample collection and separating devices the separating filter or membrane has a sufficiently small pore size to prevent cellular components from passing through the filter or membrane while allowing the passage of liquid. However, such filters or membranes often become clogged during a blood collection and plasma separation procedure thereby rendering typical vacuum forces generated by the evacuated device inadequate to draw plasma from a collected blood sample. Several examples of known blood collection and separation devices are discussed hereinafter.

U.S. Pat. No. 6,506,167 (Ishimito et al.) discloses a blood separating tube that includes an upstream tube separated by a filter from a downstream tube. The tubes are attachable to and detachable from each other and are initially provided in an evacuated state. During blood collection, blood is removed from a patient through intravenous puncture and transferred into the upstream tube through blood pressure and negative pressure inside the tube. In operation, a pressure differential is created between the upstream tube and the downstream tube as the blood contacts the filter between the two tubes. Several filter types are disclosed in this reference, including a membrane, glass fiber, filter paper with large pores and impregnated with anti-hemocyte antibodies, a filter impregnated with a cationic macromolecular substance to aggregate cells, and a laminated multi-layer filter. One problem associated with the device described in this patent is that blood cells often clog the filter during plasma separation resulting in inadequate vacuum force being present between the upstream tube and downstream tube during blood collection. A further problem with the device described in this patent is that the collected plasma in the downstream tube may be exposed to contaminants should the downstream tube be removed from the upstream tube.

U.S. Pat. No. 6,471,069 (Lin et al.) discloses a device adapted to separate plasma/serum from blood cells and includes a flexible collapsible inner container disposed within a substantially rigid outer container. A closure seals the open top end of the outer container. A filter assembly is mounted to the open top end of the inner container. The filter assembly includes a filter that permits lighter fractions of a collected fluid sample to pass therethrough, while blocking the heavier fractions. The filter assembly further includes a filter support including a slit valve that opens in response to fluid pressure created by the lighter fractions for permitting the lighter fractions to flow therethrough. In use, a fluid sample is delivered to the inner container and the device is subjected to centrifugation which causes the filter assembly to move toward the bottom end of the outer container and allow the lighter fraction of the fluid sample to flow through the slit valve and into the space between the inner and outer containers. U.S. Pat. No. 6,471,069 is incorporated herein by reference in its entirety.

U.S. Pat. No. 6,659,288 (Amano et al.) discloses a plasma/serum collection device which includes a filtering unit. The device is constructed with a space above the filtering unit to preserve the blood cells, and defines a space below the filter into which plasma/serum is drawn under negative pressure. U.S. Pat. No. 4,639,316 (Eldegheidy) discloses an automatic liquid component separator which utilizes a cross-flow filtration area together with vacuum force to cause separation of a cell-free fraction from a cell fraction in a fluid sample. Other prior art in which plasma separation through a filter within a container is achieved through a pressure differential is disclosed in U.S. Pat. Nos. 3,682,596; 3,687,296; 3,701,434; 3,814,079; 4,131,549; and 4,639,316.

The foregoing blood collection and separation devices each utilize a pressure differential as the motive force to cause plasma separation from a whole blood sample. However, certain disadvantages are present in these devices, namely there is often insufficient differential pressure for complete plasma/serum separation, the separation filters easily become clogged with cellular material, and the separated plasma/serum is easily contaminated during removal from the device. Accordingly, there is a general need for a device and method that allow for rapid separation of plasma/serum from a blood sample ideally at the same location or a close proximity to the site of sample collection.

### SUMMARY OF THE INVENTION

The present invention overcomes many of the deficiencies present in the prior art and allows a medical practitioner to both collect a bodily fluid sample, typically blood, and effect, for example, plasma/serum separation from the sample at or near the site of blood sample collection. In one embodiment, a device is provided for collecting and separating a fluid sample and generally comprises an evacuated outer container and an inner container. The outer container has a first open end and a second closed end. A pierceable closure closes the first open end thereby defining a first interior chamber. The inner container is contained within the outer container and separates the first interior chamber into an upper chamber portion in fluid communication with a lower chamber. The inner container defines a second interior chamber separated from the lower chamber portion of the first interior chamber through a porous membrane. A port is provided for placing the second interior chamber in fluid communication with the first interior chamber.

The fluid sample to be collected may comprise blood. Plasma or serum of the blood drawn within the first interior chamber passes through the porous membrane and into the second interior chamber of the inner container based on a pressure differential between the first interior chamber and the second interior chamber established by the blood contacting the porous membrane proximate the lower chamber portion. The porous membrane desirably prevents transfer of blood cells therethrough.

In one embodiment, the porous membrane may comprise filter paper, for example, one or more pieces of filter paper. The pore size of the porous membrane may be of a size to control the passing of desired molecules through the membrane. For example, the porous membrane may prevent molecules of 60,000 Daltons or higher from passing into the inner container. Additionally, the porous membrane may be capable or removing albumin, immunoglobulin, or other large molecules from the plasma or serum fraction of a blood sample. In another example, the porous membrane may prevent molecules of 10,000 Daltons or higher from passing into the inner container. Further, the porous membrane may have a pore size to enable peptide extraction from a blood sample. Moreover, the porous membrane may prevent molecules 2,000 Daltons or higher from passing into the inner container. Furthermore, the porous membrane may have a pore size to enable separation of metabolites and other small molecules from a blood sample.

The pore size of the porous membrane may also be between 0.1 μm to 2 μm. For example, the porous membrane may be a 0.22 μm membrane which may be used to remove virus particles for bio-safety plasma or serum sample collection as examples. In another example, the porous membrane may be a 0.45-1.0 μm membrane which may be used for platelet-free plasma or serum sample collection as examples. Further, the porous membrane may enable platelet-free plasma or serum sample collection.

In one variation, the inner container may be suspended within the outer container. In another variation, the inner container may be releasably connected with the pierceable closure. As a result, release of the inner container from the pierceable closure may open the port of the inner container and places the second interior chamber of the inner container in fluid communication with the first interior chamber. In a still further variation, the inner container may be movably supported within the first interior chamber of the outer container. As a result, movement of the inner container within the first interior chamber may open the port of the inner container and place the second interior chamber of the inner container in fluid communication with the first interior chamber. The outer container may support the inner container within the first interior chamber. Such support may occur after movement of the inner container within the first interior chamber.

The outer container may comprise an additive such agglutinating agents or anticoagulants. The porous membrane may be made of high density polyethylene, high density polypropylene, ceramic, porous metal, porous glass, glass fibers, polyvinyl polymers, paper, natural fibers, and combinations of the foregoing.

In another embodiment, the device is provided for separating plasma or serum from a blood sample and generally comprises an evacuated collection assembly comprising an outer container and an inner container. The outer container comprises a pierceable closure at one end. The inner container is contained within the outer container and the interior of the inner container is separated from the outer container by a porous membrane on the bottom of the inner container. The inner container comprises a port in fluid communication with the inner container. The port is desirably releasably connected to the pierceable closure.

The inner container may be entirely accommodated within the outer container. The port may be in fluid communication with the outer container, for example, when disconnected from the pierceable closure. The release of the port from the pierceable closure may enable opening of the port to unrestricted fluid communication with the outer container. The inner surface of the outer container may maintain a position of the inner container relative to the outer container. In operation, a pressure differential established between the outer container and the inner container upon entry of the blood sample into the outer container may be used to facilitate transportation of plasma or serum through the porous membrane into the inner container, while preventing the transfer of blood cells therethrough

In another aspect a method for separating plasma or serum from a blood sample is provided. The method may comprise a step of providing an evacuated collection assembly comprising an outer container having a pierceable closure at one end, an inner container contained within the outer container and defining an interior chamber therein, and a porous membrane separating the interior chamber of the inner container from the outer container. The method may further comprise a step of collecting a blood sample within the outer container of the assembly, thereby creating a pressure differential between the outer container and the inner container. The pressure differential generally causes plasma or serum from the blood sample to flow into the interior chamber of the inner container through the porous membrane. The plasma or serum flows into the inner container in a direction generally opposite to the direction of blood particle flow into the outer container during the blood sample collecting. Once collected, the plasma or serum may be removed from the inner container after the sample collection is complete. The inner container may comprise a port, and the method may further comprise a step of placing the port in fluid communication with the interior chamber of the outer container.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 is an exploded perspective view of a fluid sample collection device pursuant to one embodiment.

FIG. 2 is an exploded cross-sectional view of the device shown in FIG. 1.

FIG. 3 is a perspective view of a closure and inner container of the device shown in FIG. 1.

FIG. 4 is an assembled cross-sectional view of the device shown in FIG. 1.

FIG. 5 is an assembled cross-sectional view of the device shown in FIG. 1, showing the device in use during a fluid sample collection procedure.

FIG. 6 is an assembled cross-sectional view of the device shown in FIG. 1, showing initial fluid sample separation occurring within the device.

FIG. 7 is an assembled cross-sectional view of the device shown in FIG. 1, showing detachment of the inner container from the closure and resulting completion of fluid sample separation within the device.

FIG. 8 is an exploded perspective view of the fluid sample collection device pursuant to another embodiment.

FIG. 9 is a perspective view of the closure and inner container of the device shown in FIG. 8.

FIG. 10 is an assembled cross-sectional view of device shown in FIG. 8, showing the device accessed to accept a fluid sample for separation.

FIG. 11 is a top end view of the device shown in FIG. 8.

FIG. 12 is an assembled view of the fluid sample collection device pursuant to further embodiment, showing the device accessed to accept a fluid sample for separation.

FIG. 13 is an assembled cross-sectional view of the device shown in FIG. 1 with an alternative closure for the device.

FIG. 14 is an assembled cross-sectional view of the device shown in FIG. 1 with another alternative closure for the device

### DESCRIPTION OF PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

In one embodiment, a fluid sample collection device suitable for the collection of a blood sample and the separation of plasma, serum, or other fluid specimens from the cellular material (i.e., blood cells) of the blood sample is disclosed. However, the device described herein is generally applicable for separating solution (i.e., liquids) from solids like a filtration device. In particular, in one form, the device is adapted for collection of a blood sample through conventional sampling techniques and subsequent separation thereof by use of an assembly of components generally including an inner container, an outer container, and a closure member. The inner container generally draws plasma, serum, or other liquid specimens through a porous membrane, filter, or like separating member from the outer evacuated container to separate the plasma, serum, and/or other liquid specimen from the sample.

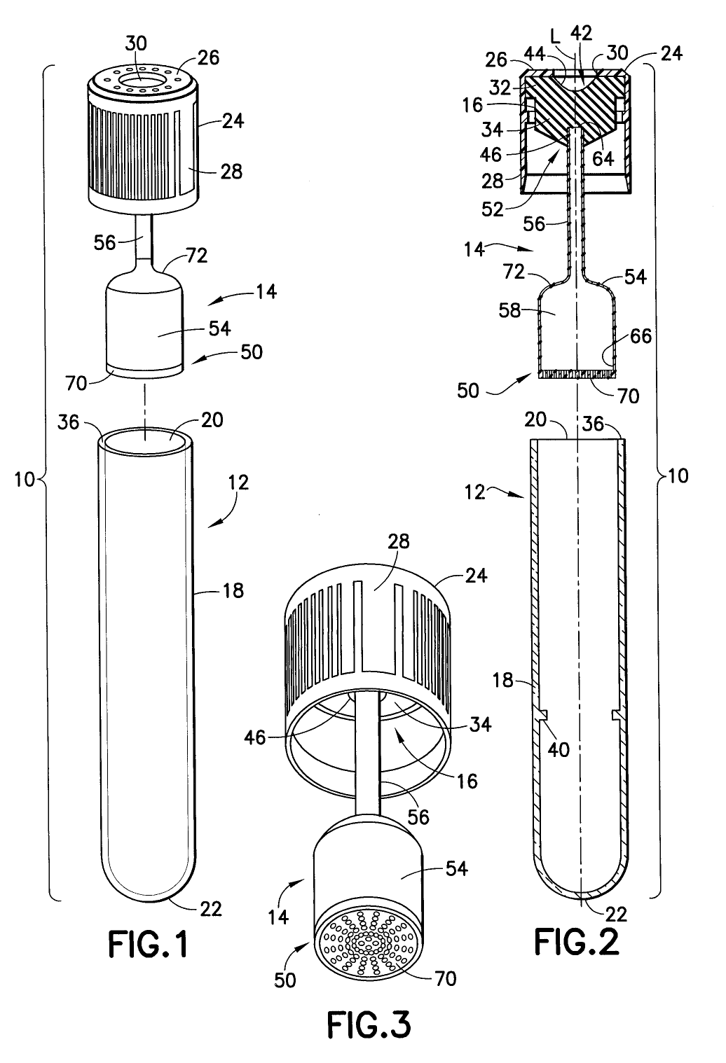

Referring initially to FIGS. 1-4, a device 10 for collecting and separating a fluid sample is generally shown. Device 10 is an assembly of components, namely a first or outer container or tube 12, a second or inner container or tube 14, and a closure 16 for sealing outer and inner containers 12, 14. Outer and inner containers 12, 14 together form, pursuant to one embodiment, an evacuated collection assembly. Generally, outer container 12 encompasses inner container 14, typically entirely accommodating the inner container 14 therein. Outer container 12 may be any container or vessel capable of containing a fluid sample, typically a blood sample, therein, and is desirably in the form of a conventional blood collection tube or vessel that may be evacuated by conventional means. Outer container 12 may be constructed of any known material, such as glass or molded plastic material and, in one particular embodiment, is constructed of polyethylene terephthalate (PET). Closure 16 is provided to make an air-tight seal with the outer container 12 and enclose inner container 14 within outer container 12. Closure 16 is also used to support inner container 14 within outer container 12, for example, in a suspended manner within the outer container 12.

Outer container 12 is a generally cylindrical-shaped structure comprising a tubular sidewall 18 defining a first open or top end 20 and further forming a second closed or bottom end 22 of the outer container 12. The closed end 22 may have a rounded or arcuate form as a conventional blood collection tube. Outer container 12 is sealed at open end 20 by closure 16 which is a pierceable component formed of rubber or molded plastic material but may be made of any pierceable elastomeric material. While closure 16 is generally akin to rubber or plastic tube stoppers known in the medical art, closure 16 possess several novel features in its own right as discussed herein. Closure 16 is surrounded, at least in part, by a cap structure or member 24 which is included for protecting the closure 16 when seated within the open end 20 of outer container 12. Cap member 24 is formed with an annular end wall 26 and a depending sidewall or skirt 28 which is configured to extend downward along sidewall 18 of outer container 12 when closure 16 is seated within the open end 20 of the outer container 12. As discussed herein, closure 16 includes an insertable portion which is seated within the open end 20 of outer container 12 and which is held therein by frictional engagement with the inner surface or side of sidewall 18 and/or with an adhesive. Sidewall 28 of cap member 24 extends downward along the outer surface or side of sidewall 18 of outer container 12 to protect the exposed portion of closure 16 extending outward from the open end 20 of the outer container 12. Annular end wall 26 defines a central aperture 30 to expose a portion of closure 16 to allow access to the interior of outer container 12, which is typically accessed by a piercing element, such as a needle cannula, which is inserted through the pierceable closure 16 as described in greater detail herein.

Closure 16 is typically a unitary structure or body formed of rubber, plastic or another similar polymeric material, as described previously, and is generally an elastomeric closure element that is formed of suitable material capable of forming a substantially gas and liquid-tight seal with the open end 20 of outer container 12. Additionally, the body of closure 16 is desirably capable of being punctured with a puncturing device, such as a needle cannula, as described previously. Such a needle cannula may be part of a blood collection device used to transfer blood into outer container 12. Closure 16 is formed with a flanged head or cap portion 32 and a depending and integrally molded plug portion 34. Cap portion 32 is adapted to seat or rest on a rim 36 defined by sidewall 18 of outer container 12 at the open end 20 of the outer container 12. Plug portion 34 is generally adapted to be inserted into the open end 20 of outer container 12 and extend inward into the outer container 12 and form a substantially gas and liquid-tight seal with the inner surface or side of sidewall 18. Thus, with plug portion 34 of closure 16 seated within the open end 20 of outer container 12, a first interior chamber 38 is defined or formed within the outer container 12. First interior chamber 38 may be placed under negative (i.e., vacuum) pressure with respect to external atmospheric pressure prior to sealing closure 16 in the open end 20 of outer container 12, such that the interior of outer container 12 is under negative (i.e., vacuum) pressure. For example, after assembly of device 10 wherein inner container 14 is inserted in outer container 12, the outer container 12 may be evacuated and subsequently sealed with closure 16 thereby placing first interior chamber 38 under negative (i.e., vacuum) pressure and simultaneously placing the interior of inner container 14 under negative (i.e., vacuum) pressure.

Another aspect of device 10 relates to inner container 14 being movable within outer container 12 to accomplish full separation of the collected fluid sample. As shown in FIG. 2, an internal limiting structure 40 is provided within first interior chamber 38 which is used to limit internal movement of inner container 14 within outer container 12, as discussed further herein. In the embodiment illustrated, limiting structure 40 is in the form of a circumferential flange or tab that extends inward from sidewall 18 of outer container 12 and, thus, is typically formed integrally with the body of outer container 12. However, the specific movement-limiting structure illustrated in FIG. 2 as limiting structure 40 should not be considered to limit the possible range of variations for limiting structure 40. Such variations may take many forms, such as a circumferential restriction (i.e., narrowing) formed in sidewall 18 of outer container 12, a sleeve structure disposed within outer container 12 and extending upward from the closed end 22 thereof, a platform extending upward from the closed end 22 of outer container 12, one or more posts or tabs extending radially inward from sidewall 18 of outer container 12, and like structures.

Cap portion 32 of closure 16 defines a top surface 42 which is typically partially enclosed by the annular end wall 26 of cap member 24. Top surface 42 is exposed in the open area defined by central aperture 30 in cap member 24, and this exposed area of top surface 42 is where a user of device 10 inserts a needle cannula or like piercing element to access the interior of outer container 12 and first interior chamber 38 in particular. Accordingly, to provide a blood sample to the first interior chamber 38, a needle cannula or like piercing element of a blood collection device is used to penetrate the exposed portion of the top surface 42 of cap portion 32 of closure 16 which places the first interior chamber 38 in fluid communication with a needle inserted into a patient's vein for blood collection purposes. Since first interior chamber 38 is sealed and under negative (i.e., vacuum) pressure, blood flows from the vein, through the blood collection device, and into the first interior chamber 38 via the needle cannula inserted through closure 16. If desired, the top surface 42 of cap portion 32 of closure may be recessed or otherwise shaped to provide a visual indication or cue of where to insert a needle cannula to appropriately penetrate the closure 16 and access the interior of outer container 12 without striking inner container 14. This recessed or shaped area is designated by reference numeral 44 in FIGS. 1-7 and is desirably part of the area of top surface 42 left exposed by central aperture 30 defined in the annular end wall 26 of cap member 24. Further, plug portion 34 defines a bore or tubular shaped recess 46 which is provided to support inner container 14 within outer container 12, with inner container 14 depending or being suspended from plug portion 34 and extending into the first interior chamber 38 defined by outer container 12 and closure 16.

Second or inner container 14 is a generally tubular or cylindrical structure in analogous manner to outer container 12 but may take other forms. Inner container 14 is desirably contained fully within outer container 12 and is initially associated with and supported by closure 16 to extend into the outer container 12. In one embodiment, inner container 14 is a generally bell-shaped structure or unitary body which includes a first or distal end 50 and a second or proximal end 52. Inner container 14 is generally comprised by a bell-shaped containment portion 54 defining or forming the distal end 50 and a tubular structure or conduit 56 that extends upward from containment portion 54 and defines or forms the proximal end 52 of the inner container 14. Tubular conduit 56 forming the proximal end 52 of inner container 14 is adapted to engage the bore 46 defined in plug portion 34 of closure 16 whereby the inner container 14 may be suspended within outer container 12. Containment portion 54 is hollow and defines a second interior chamber 58 which is in fluid communication with the upward-extending tubular conduit 56.

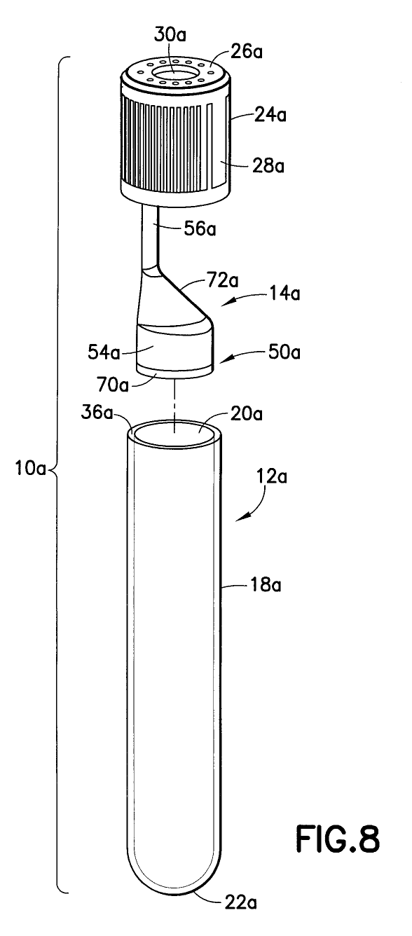

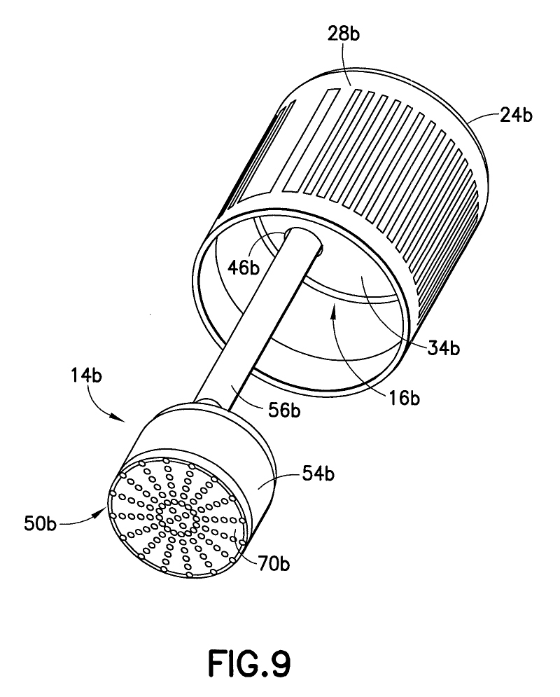

In the embodiment illustrated in FIGS. 1-4, tubular conduit 56 is coaxially aligned and extends upward from containment portion 54 to engage bore 46 which is further desirably coaxially aligned with central aperture 30 in cap member 24. However, the diameter of tubular conduit 56 and, thus, bore 46 is desirably smaller than central aperture 30 to allow a user to insert a needle cannula through closure 16 in an area radially outward from the proximal end 52 of inner container 14 and, hence, radially outward from tubular conduit 56. As a result, the inserted needle cannula is inserted generally parallel to tubular conduit 56, and is not inserted directly into tubular conduit 56. The proper insertion of a needle cannula through closure 16 is shown in FIG. 5 discussed herein. It will be appreciated from the foregoing that inner container 14 and outer container 12 are also coaxially aligned by the coaxial engagement of tubular conduit 56 in bore 46 in plug portion 34 of closure 16. In other embodiments discussed herein, inner container 14 and closure 16 may be configured such that inner container 14 is radially offset from a central axis L of outer container 12, as shown in FIGS. 8-12 discussed herein.

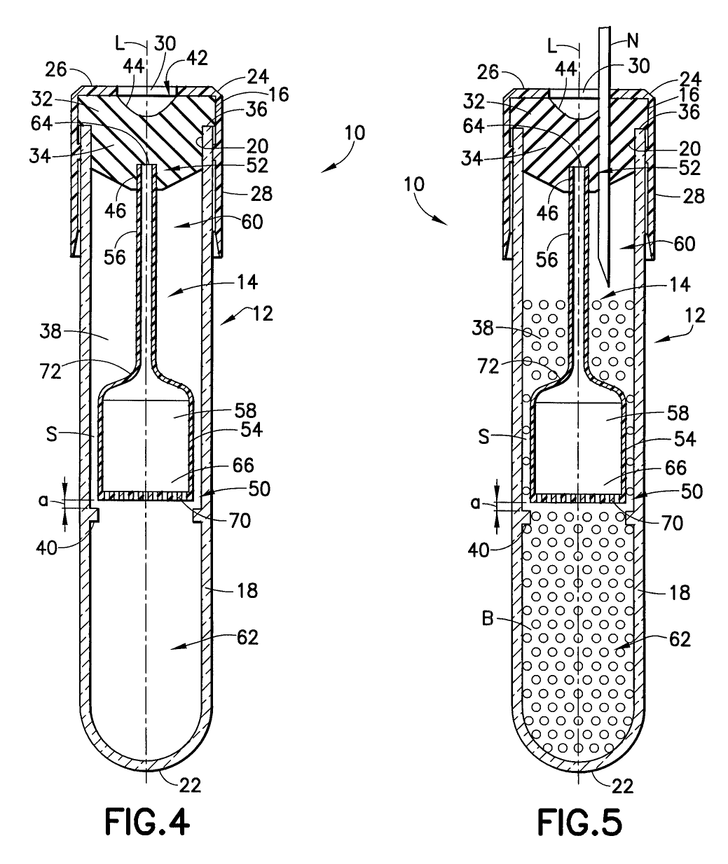

As described previously, in one embodiment, inner container 14 depends (i.e., is suspended) from closure 16 and is supported to closure 16 by frictional and/or adhesive engagement of tubular conduit 56 in bore 46 defined in plug portion 34 of the closure 16. Thus, with the foregoing engagement, the proximal end 52 of inner container 14 is secured to closure 16 with the distal end 50 projecting into the first interior chamber 38 when the closure 16 is inserted into and secured in the open end 20 of outer container 12. As shown in FIG. 4, for example, the distal end 50 of inner container 14 is spaced a distance “a” from limiting structure 40 which extends radially inward from the sidewall 18 of outer container 12. The positioning of inner container 14 within outer container 12 further separates or segregates the first interior chamber 38 into an upper chamber portion 60 and a lower chamber portion 62. Upper chamber portion 60 is generally defined by the area above bell-shaped containment portion 54 and the lower chamber portion 62 is generally defined by the area below the containment portion 54 (i.e., the area below distal end 50). Containment portion 54 has an outer diameter that is less than the inner diameter of outer container 12 to allow fluid to flow downward to lower chamber portion 62 from upper chamber portion 60 along the inner surface of the sidewall 18 of the outer container 12 once introduced into the upper chamber portion 60 via, for example, a needle cannula. Thus, annular spacing “S” between the outer diameter of containment portion 54 and the inner diameter of outer container 12 is sufficient to allow the free flow of liquid, such as blood, from the upper chamber portion 60 to the lower chamber portion 62.

Tubular conduit 56 of inner container 14 further acts as a port which, during use of device 10, is adapted to selectively place the second interior chamber 58 defined by containment portion 54 of inner container 14 in fluid communication the first interior chamber 38 defined by the confines defined by outer container 12 and closure 16. Such a port is generally defined by an opening or port 64 at the end of tubular conduit 56 and, hence, at the proximal end 52 of inner container 14. To allow “outlet” port or opening 64 to be in fluid communication with the interior of outer container 12, tubular conduit 56 is desirably releasably disposed in bore 46 in plug portion 34 of closure 16 and thereby releasably connected to closure 16. Thus, in order for outlet port or opening 64 to be in fluid communication with the fist interior chamber 38, tubular conduit 56 must first be released of engagement with closure 16. Once released of engagement, inner container 14 moves downward within outer container 12 under the force of gravity and/or by force exerted by a user of device 10 as described herein. However, the length of downward movement is limited by limiting structure 40 disposed within outer container 12. In particular, the interference engagement between the distal end 50 of inner container 14 and limiting structure 40 limits downward movement of the inner container 14 within outer container 12 to distance a. Distal end 50 of inner container 14 is desirably fully open so that containment portion 54 defines an end opening 66 for admittance of fluid into the containment portion 54. End opening 66 may be the diameter of containment portion 54 or have a smaller diameter than the containment portion 54.

The second interior chamber 58 defined by inner container 14 and, in particular, by containment portion 54 is separated from the first interior chamber 38 defined by outer container 12 and closure 16 by a porous member or filter element 70. Typically, porous membrane 70 is adapted to separate plasma or serum from a whole blood sample, as will be discussed in more detail herein. Porous membrane 70 is disposed in or over end opening 66 in containment portion 54 and fully covers end opening 66 on an opposite side of a top end or side 72 of the containment portion 54. Additionally, porous membrane 70 may be formed as a disk-shaped structure with a filtering center area which is secured to the distal end 50 of inner container 14 and fully covers end opening 66 in containment portion 54, thereby also forming the distal end of containment portion 54. Porous membrane 70 may be constructed of any suitable material including pores which are large enough to draw plasma or serum therethrough under a normal negative (i.e., vacuum) pressure of a conventional evacuated blood collection tube, but small enough to prevent blood cell cells, including red cells, white blood cells, platelets, etc., and aggregates such as blood clots from passing therethrough. As examples, porous membrane 70 may be comprised of high density polyethylene, high density polypropylene, ceramic, porous metal, porous glass, glass fibers, polyvinyl polymers, paper, natural fibers, and combinations thereof. As used herein, the terms “porous membrane” and “filter” or “filter element” are used interchangeably and can relate further to a column-like filter, a filter paper (i.e., Whateman paper), two or more stacked filter papers, a single membrane, or multiple membranes. Variations of the structural shape or supporting structure of porous membrane 70 are therefore contemplated and are within the skill of those skilled in the art. In general, filter paper used for porous membrane 70 is suitable for separating cells from plasma/serum and a membrane 70 with a selected pore size according to the molecular weights of proteins may be used to separate proteins which are smaller than the selected pore size from a collected blood sample.

The pore size of porous membrane 70 may be varied according to the required selectivity need by the user in separating a fluid sample. For example, the pore size of porous membrane 70 may be selected to achieve a selectivity according to the molecular weight of molecules desired to pass through the membrane. A pore size of 60,000 Daltons is used to prevent proteins or other macormolecules with 60,000 or higher molecular weight from passing to the second interior chamber 58. Alternatively, porous membrane 70 may be adapted to remove albumin, immunoglobulin, and/or other large molecules from the collected plasma or serum. Further, porous membrane 70 may be a molecular weight cut-off membrane of 10,000 Daltons or less for peptide extraction from the blood sample, or a molecular weight cut-off membrane of 2,000 Daltons or less to separate metabolites and other small molecules for biochemical analysis.

A porous membrane 70 having a pore size smaller than 50,000 Daltons allows only molecules smaller than 50,000 Daltons to pass through the porous membrane 70 so that, in addition to cells and clots, albumin, antibodies, and other large molecules remain in outer container 12 and do not pass to inner container 14. This is important in the context of biomarker discovery, as albumin and many other large molecules in high abundance in blood often are not meaningful and can, thus, be easily removed. A porous membrane 70 of 3,000-10,000 in pore size allows only peptides less than about 3,000-10,000 Daltons to pass through. These peptides are ready for proteomic and diagnostic analysis. For general plasma or serum collection, a regular filter paper or porous membrane with a 0.45-1.0 μm pore size can be used for porous membrane 70. This porous membrane 70 can remove all blood cells including platelets and, therefore, the collected plasma or serum in inner container 14 is a platelet-free sample. As a further example, when a porous membrane 70 with a pore size of about 0.22 μm is used, bacteria cells and viral particles, such as HIV, in addition to all blood cells, will not pass to inner container 14 and will be retained in lower chamber portion 62. As a result, the plasma or serum collected in inner container 14 will be free of infection, providing bio-safety plasma or serum samples for downstream laboratory analysis. A desirable pore size range for the removal of bacteria cells and viral particles is about 0.1 μm to 2 μm. Membranes with pore sizes of 3,000, 10,000, 30,000, 50,000, 100,000, and 200,000 Daltons are commercially available.

It is contemplated that outer container 12 may include cell metabolism regulators, an agglutinating agent, and/or an anticoagulant therein. Agglutinating agents are used to create large aggregates of cells, which facilitates the filtering process. Suitable agglutinating agents include, but are not limited to, lectins, such as potato or wheat lectins. Alternative agglutinating agents may include antibodies with an affinity for blood cells attached to microbeads. The agglutinating agent may also be in the form of a solution, pellet, pill, or lyophilized specimen, such as granules, coated on a separate structure or coated on an inner surface of outer container 12, and/or both outer and inner surfaces of inner container 14. An anticoagulant such as heparin, EDTA, sodium citrate, or other known compound for preventing coagulation of blood can also be used. The term “agglutinating agent” is used to denote the use of an agglutinating agent alone to form cell aggregates, or the use of an agglutinating agent in combination with a structure that can impart desired properties to the cellular aggregates. For example, the structure may be a microbead of a particular density, coated with an agglutinating agent. In another example, the structure can have a specific geometry, such as a string or cylinder, to impart a desired shape to the aggregates, such as a shape that is less densely packed than cellular aggregates without the structure, and which permits plasma to pass through the aggregates. The foregoing examples are not intended to be limiting, and any structure having the desired properties may be used as the starting particles for forming the cellular aggregates. In all embodiments described herein, the term “agglutinating agent” will refer to the use of an agglutinating agent alone, or in combination with a structure as described hereinabove, which has been coated with an agglutinating agent.

Inner container 14 may also optionally include an additive or additives similar to those in outer container 12 but which can interact only with the separated liquid, typically plasma or serum. Many additives have been found to cause hemolysis and other damage to blood cells. Accordingly, a benefit of the provided by the dual outer and inner containers 12, 14 structure described in the foregoing description is the ability to place distinct additives in inner container 14 where they will not come into contact with blood cells present in the whole sample (i.e., in first interior chamber 38) thereby reducing any adverse effects to the blood cells. Examples of additives include anticoagulants, detergents, preservatives, and enzymatic inhibitors such as protease inhibitors such as 4-(2-Aminoethyl)-benzenesulfonyl fluoride hydrochloride (AEBSF).

The overall size of outer and inner containers 12, 14 are varied to provide predetermined relative differences in volume between the outer and inner containers 12, 14 and, correspondingly, predetermined relative differences between the upper and lower chamber portions 60, 62. These predetermined relative differences can be chosen according to known characteristics of the collected fluid sample, typically blood. For example, the volume of the lower chamber portion 62 may be designed to be about 5× ml of fluid sample (i.e., blood), while the volume of inner container 14 (including containment portion 54 and tubular conduit 56) is about 3× ml resulting in a ratio of volumes of about 5:3 which corresponds to the volume ratio of cells-pellets to plasma in whole blood. “X” in the foregoing can be any whole number or fraction (i.e., 0.05-10) and can be changed according to the total volume of the first interior chamber 38 in outer container 12. The total volume of the upper chamber portion 60 is about 6× ml and the total sample volume available in device 10 is about 8× ml in the foregoing example.

To assemble device 10, inner container 14 is affixed to closure 16 by inserting tubular conduit 56 into bore 46 in plug portion 34 of the closure 16 forming an assembly structure comprised of inner container 14 and closure 16, with inner container 14 suspended or depending from closure 16. Outer container 12 and the assembly of inner container 14 and closure 16 are placed into an evacuator and, when a desired vacuum level is reached, inner container 14 and closure 16 are inserted into the open end 20 of outer container 12. Once this assembly is disposed in outer container 12, plug portion 34 of closure 16 is inserted into the open end 20 of outer container 12 which engages the inner surface of sidewall 18 of the outer container 12 and forms a gas and liquid-tight seal with the inner surface of the sidewall 18. Cap portion 32 of closure 16 rests on the rim 36 of outer container 12. Typically, cap member 24 is preassembled to closure 16, with annular end wall 26 engaged with the top surface 42 of cap portion 32 of the closure 16 and the sidewall 28 of the cap portion 32 extending around the circumference of closure 16. With closure 16 sealed in the open end 20 of outer container 12, both the first interior chamber 38 defined by outer container 12 and the second interior chamber 58 defined by inner container 14 are at negative (i.e., vacuum) pressure. Device 10 is now ready for a fluid collection and separation procedure.

Referring further to FIGS. 5-7 in addition to FIGS. 1-4, operational use of device 10 in the collection and separation of a whole blood sample will now be discussed. As indicated immediately above, device 10 is initially provided in an evacuated state with inner container 14 depending from closure 16 and extending into outer container 12 and both containers 12, 14 in an evacuated state. The first interior chamber 38 is in fluid communication with the second interior chamber 58 through porous membrane 70 which is adapted to separate plasma or serum from the cellular components of a whole blood sample. A blood sample B is introduced into outer container 12 via a needle cannula N which is inserted through closure 16 and into the first interior chamber 38 in outer container 12. Needle cannula N may be associated with a conventional blood collection device or set as described previously. Needle cannula N is inserted into the top surface 42 of closure 16 in the area left exposed by central aperture 30 in cap member 24, with the recessed area 44 in the top surface 42 providing a visual indication or cue of where to insert the needle cannula N to appropriately penetrate the closure 16 and access the interior of outer container 12 without striking or entering inner container 14. Blood sample B is drawn into the first interior chamber 38 in outer container 12 based on the negative (i.e., vacuum) pressure therein, and flows downward from the upper chamber portion 60 to the lower chamber portion 62 of the first interior chamber 38 through circumferential spacing or gap S between the inner container 14 and outer container 12. Blood sample B fills the lower chamber portion 62 to a level where it reaches porous membrane 70. When the blood sample B reaches porous membrane 70, the pressure in inner container 14 is approximately equal to that of outer container 12. As additional blood sample B fills outer container 12, it covers the outer or exposed surface of porous membrane 70 until the outer container 12 (i.e., into upper chamber portion 60) is filled with the total volume of the sample to be taken, based upon the vacuum pressure available within the outer container 12. At this point, no further sample can be drawn as the negative (i.e., vacuum) pressure within the first interior chamber 38 is exhausted or insufficient to continue sample collection and collection of blood sample B ceases. Additionally, the level of blood sample B in outer container 12 is above the inlet to inner container 14 (i.e., above porous membrane 70) and a pressure differential exists between the outer and inner containers 12, 14. A residual negative (i.e., vacuum) pressure is present within inner container 14 after blood sample B collection which adds to the pressure differential present between the outer and inner containers 12, 14 due to the liquid height differential between the outer and inner containers 12, 14.

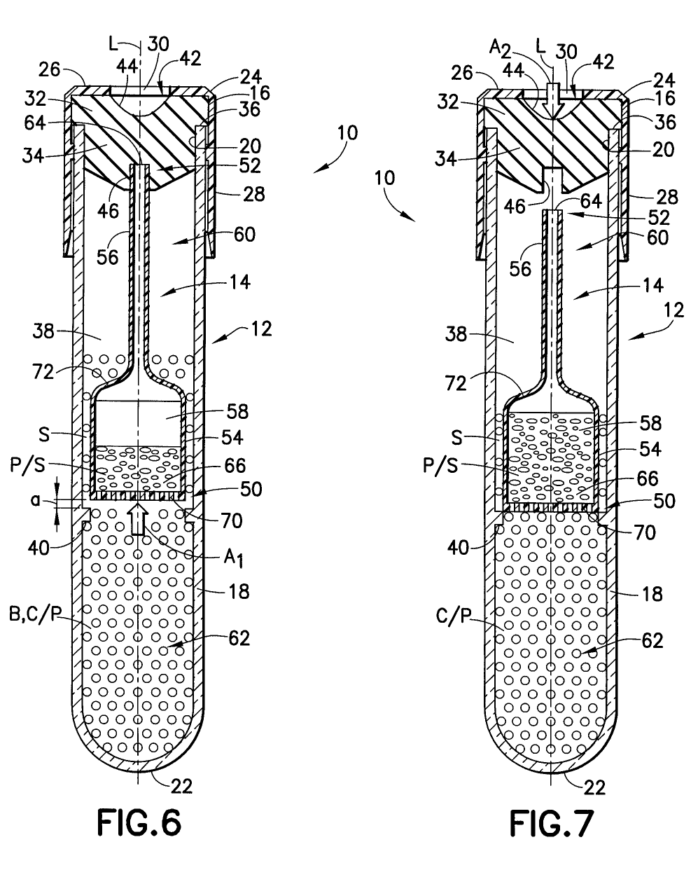

With the level of blood sample B in outer container 12 being above porous membrane 70 and a residual vacuum being present within inner container 14, a pressure differential exists between the outer container 12 and inner container 14, with the first interior chamber 38 in the outer chamber 12 being at a higher pressure than the second interior chamber 58 in inner container 14. This pressure differential forces the liquid portion of the collected blood sample B, which is plasma or serum (hereinafter “P/S”), through filtering porous membrane 70. In particular, plasma or serum P/S passes through porous filter 70 in the direction of arrow A₁ and enters the second interior chamber 58 defined by inner container 14 and containment portion 54 of inner container 14 in particular, while the blood sample B moves in the opposite direction to arrow A₁ (i.e., downward) in outer container 12. Porous membrane 70 prevents cellular material and platelets (hereinafter “C/P”) from entering the second interior chamber 58 defined by inner chamber 14 and containment portion 54 in particular. At this point, as illustrated in FIG. 6, only a portion of blood sample B is filtered with a partially recovered or separated portion of the plasma or serum P/S present within the second interior chamber 58 defined by inner chamber 14 and containment portion 54 thereof, as the residual vacuum in inner container 14 is now substantially exhausted. Additional plasma or serum P/S is present in blood sample B but the remaining pressure differential present between the height level of blood sample B in the first interior chamber 38 (i.e., in upper chamber portion 60) in outer container 12 and the height level of plasma or serum P/S in the second interior chamber 58 in inner container 14 (i.e., in containment portion 54) is insufficient to cause further separation.

Referring now in particular to FIG. 7, additional separation of blood sample B can be effected by increasing the pressure differential between the level of blood sample B in the first interior chamber 38 in outer container 12 and the level of plasma or serum P/S in the second interior chamber 58 in inner container 14. This is accomplished by a user of device 10 pressing downward on the top surface 42 of closure 16 in the open area defined by annular end wall 26 which has the effect of releasing inner container 14 from the closure 16. In particular, the user presses down on closure 16 in the direction of arrow A₂ which causes tubular conduit 56 to be released from bore 46 defined in the plug portion 34 of the closure 16. Once released of engagement with the plug portion 34 of closure 16, port 64 in tubular conduit 56 places the second interior chamber 58 in inner container 14 in fluid communication with the upper chamber portion 60 of the first interior chamber 38 in outer container 12. Additionally, substantially simultaneously, inner container 14 moves downward in outer container 12 under the force applied in the direction of arrow A₂ and/or by the force of gravity. This downward movement is interrupted when the distal end 50 of inner container 14 comes into interference contact with limiting structure 40 in outer container 12. Thus, inner container 14 is movably supported within outer container 12.

With the disengagement of inner container 14 from closure 16 as just described, an air pressure equalization is now present between the upper chamber portion 60 of the first interior chamber 38 in outer container 12 and the second interior chamber 58 in inner container 14. However, with the downward movement of inner container 14 within outer container 12, additional height differential exists between the level of blood sample B in the upper chamber portion 60 of the first interior chamber 38 and the level of separated plasma or serum P/S in the second interior chamber 58. This height differential provides additional pressure differential which “presses” additional plasma or serum through porous membrane 70. Separation of plasma or serum P/S continues until the level of plasma or serum P/S in the second interior chamber 58 in inner container 14 substantially equalizes with the level of cellular material/platelets C/P in the first interior chamber 38 in outer container 12, as substantially shown in FIG. 7. At this point, the first interior chamber 38 and, primarily, the lower chamber portion 62 thereof contains cellular material/platelets C/P while the second interior chamber 58 contains plasma or serum P/S. Separation can also be accomplished by disconnecting inner container 14 from outer container 12 in the manner just described and then placing device 10 in a centrifuge and spinning at a proper G-force for 10-30 minutes. It will be appreciated that closure 16 is desirably made of an elastomeric material with sufficient resiliency to allow a user of device 10 to press down on the closure 16 and cause sufficient expansion of bore 46 in the plug portion 34 of the closure 16 with finger pressure alone to cause tubular conduit 56 to become disengaged from the bore 46. Moreover, this finger pressure alone may be sufficient to simply eject tubular conduit 56 from bore 46 in the plug portion 34 of the closure 16.

As will be appreciated from the foregoing blood collection and separation example, closure 16 may be removed and inner container 14 removed from outer container 12. Plasma or serum P/S present in the second interior chamber 58 in inner container 14 can then be accessed for downstream tests. Additionally, the first interior chamber 38 in outer container 12 contains primarily cellular material and platelets C/P which again can be removed for downstream testing.

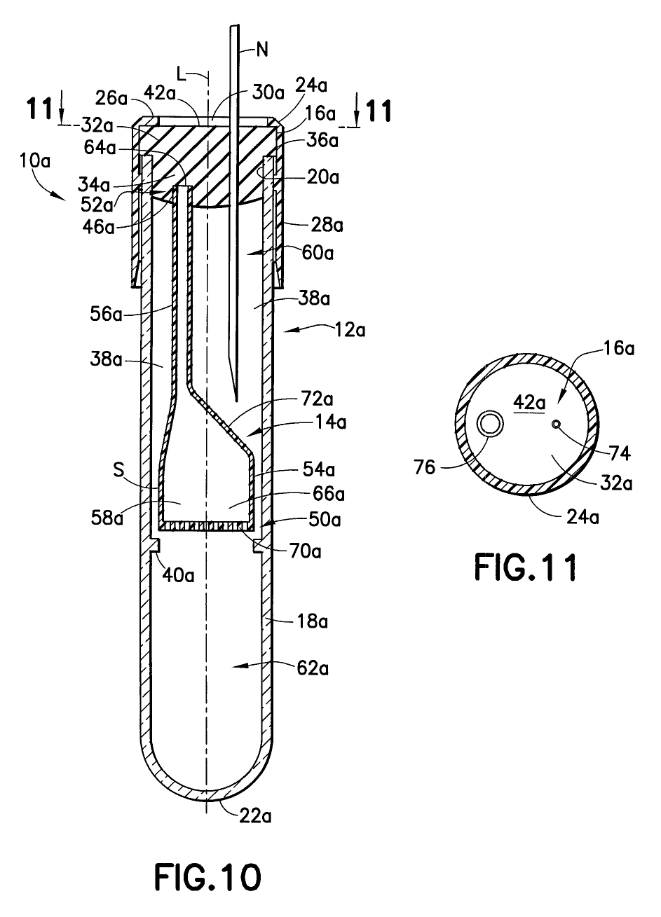

Referring to FIGS. 8-11, another embodiment of device 10a is shown. Device 10a is similar in most respects to device 10 discussed previously but includes certain modifications to inner container 14a and closure 16a. In device 10a, tubular conduit 56a extending from containment portion 54a of inner container 14a is offset radially from a central axis of the containment portion 54a. As a result, the top end or side 72a of containment portion 54a is tapered or angled to form the transition to the tubular conduit 56a. As tubular conduit 56a is no longer coaxially aligned with containment portion 54a, inner container 14a itself cannot be mounted to closure 16a in the manner described previously. Closure 16a is now formed to accommodate the offset axis configuration of tubular conduit 56a of inner container 14a. In particular, bore 46a in the plug portion 34a of closure 16a is offset radially from the central axis of the closure 16a and, thus, from the central axis L of outer container 12a when the closure 16a is seated in the open end 20a of the outer container 12a. Accordingly, tubular conduit 56a lies along an axis offset radially and generally parallel to the central axis L of outer container 12a when the tubular conduit 56a is joined to closure 16a and the closure 16a is seated in the open end 20a of the outer container 12a. As will be appreciated from FIG. 10, containment portion 54a of inner container 14a lies generally coaxially aligned with the central axis L of outer container 12a, only tubular conduit 56a is offset radially from the central axis L.

The radially offset configuration of tubular conduit 56a provides additional clearance to one side of the tubular conduit 56a for insertion of needle cannula N into outer container 12a, as shown in FIG. 10. This additional clearance provides a user of device 10a with additional space for inserting needle cannula N into outer container 12a and helps minimize the possibility of inserting the needle cannula N directly into tubular conduit 56a by mistake. To further aid the user in inserting needle cannula N correctly into outer container 12a, closure 16a is slightly modified as shown in FIGS. 10 and 11 and, in particular, slightly modified over closure 16 discussed previously. Modified closure 16a includes a generally planar top surface 42a which features two markings. One or a first marking 74 denotes the appropriate location for the user of device 10a to insert or pierce closure 16a with needle cannula N while a second marking 76 denotes the location of the end of tubular conduit 56a, which is also the proximal end 52 of the inner container 14a. As a result, the user is made aware of the location of tubular conduit 56a and, further, the appropriate location to pierce closure 16a with needle cannula N. If desired, the central aperture 30a in the annular end wall 26a of cap member 24a may be made larger to provide a greater degree of separation between the first marking 74 denoting the location for insertion of needle cannula N and the second marking 76 denoting the location of tubular conduit 56a. Second marking 76 also aids the user in locating his or her finger(s) to apply the force necessary to dislodge tubular conduit 56a from bore 46a during a fluid sample collection and separation procedure. Other than the foregoing differences, device 10a is similar in all respects to device 10 and operates in an analogous manner to device 10 as detailed previously.

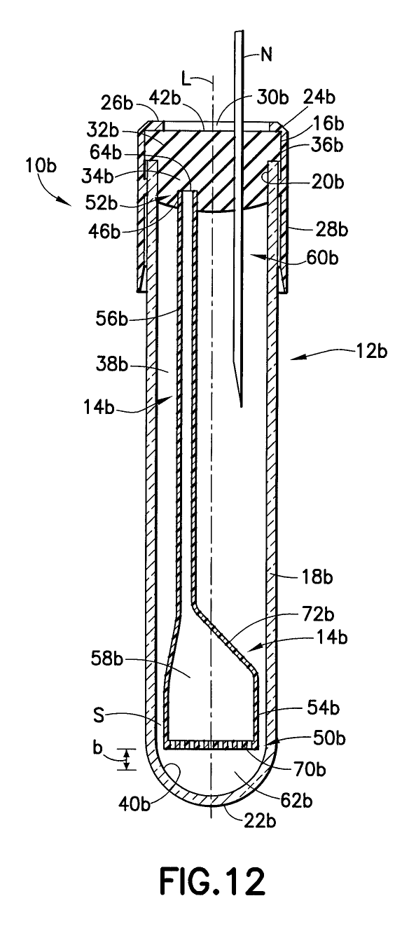

FIG. 12 shows a further embodiment of device 10b which is similar in most respects to devices 10a just discussed and includes the same modifications to inner container 14b and closure 16b as found in inner container 14a and closure 16a. Device 10b differs from device 10a in that limiting structure 40a found on the sidewall 18a of outer container 12a of device 10a is not present in outer container 12b. In device 10b, closed end 22b of outer container 12b forms the limiting structure for limiting downward movement of inner container 14b in outer container 12b during a fluid sample collection and separation procedure involving device 10b. As the closed end 22b forms the movement limiting structure for inner container 14b, it will be apparent from FIG. 12 that tubular conduit 56b is elongated over tubular conduit 56a detailed previously. Other than the two foregoing differences, device 10b is similar in all respects to device 10a and operates in an analogous manner as device 10b with a few minor differences as detailed herein.

In use, device 10b collects a fluid sample in the manner described previously. Such a collection procedure begins with the insertion of needle cannula N through closure 16b and the depositing of a fluid sample in the first interior chamber 38b in outer container 12b. Separation of the fluid sample commences as described previously in connection with device 10. As shown in FIG. 12, the distal end 50b of inner container 14b is separated by a distance “b” from the closed end 22b of outer container 12b. Distance b is approximately the same distance as distance or length a described previously in connection with device 10. When it is desired to “complete” the fluid sample separation, the user of device 10b initiates the detachment or disengagement of tubular conduit 56b from closure 16b in the manner described previously, but inner container 14b is limited in its downward movement by interference contact between the distal end 50b of the inner container 14b and the closed end 22b of the outer container 12b. Final fluid sample separation occurs when the distal end 50b of inner container 14b abuts against the closed end 22b of outer container 12b which forms the limiting structure limiting movement of the inner container 14b within the outer container 12b in this embodiment. This final separation procedure is similar to the final fluid sample separation which occurs when inner container 14 is released of engagement with closure 16 and moves downward to contact limiting structure 40 within outer container 12 in device 10.

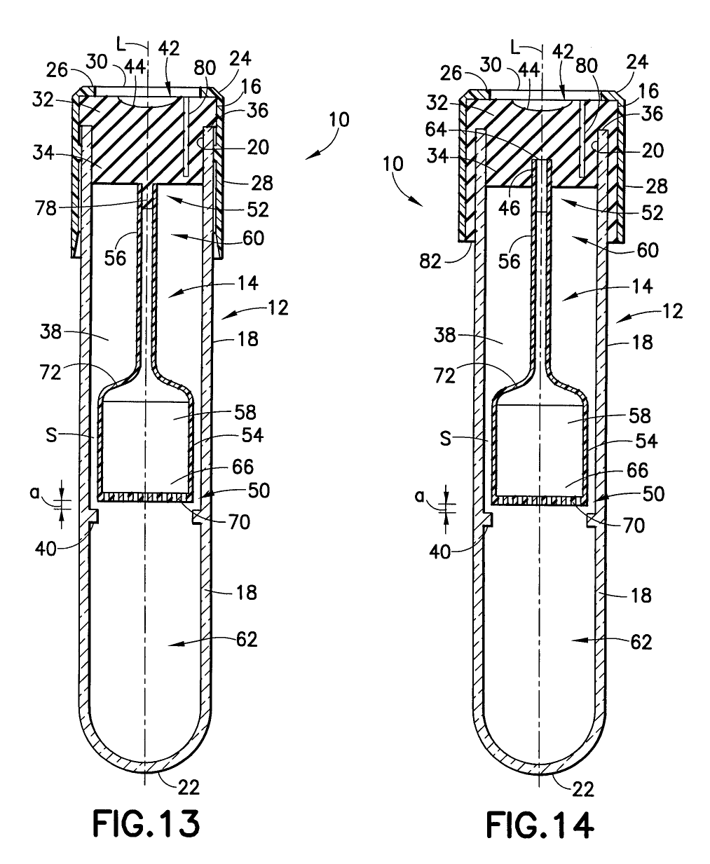

FIGS. 13-14 show two modifications to closure 16 which may be used in any of the embodiments of device 10, 10a, 10b described hereinabove. In FIG. 13, closure 16 includes a depending portion 78 which depends from plug portion 34 and which is intended to replace bore 46 as the carrying structure for tubular conduit 56 of inner container 14. Accordingly, depending portion 78 extends into the end opening 66 in tubular conduit 56 and frictionally engages the inner surface or side of the sidewall of tubular conduit 56 to suspend inner container 14 from closure 16. As further shown in FIG. 13, a needle guide slot 80 may be defined in closure 16 and which extends through cap portion 32 and partially through plug portion 34 to help guide a user in locating a needle cannula (not shown) at the proper location to puncture or pierce the closure 16 to admit a fluid sample into the first interior chamber 38 in outer container 12. Such a needle guide slot 80 is applicable to all the closures 16, 16a, 16b described previously. The central aperture 30 defined by annular end wall 26 of cap member 24 may be sized (i.e., enlarged) in a similar manner to central aperture 30a defined by annular end wall 26a of cap member 24a so that additional radial clearance may be provided between the needle guide slot 80 the proximal end 52 of inner container 14.

In FIG. 14, closure 16 includes a circumferential rim 82 which is formed as part of cap portion 32 and is configured to overlap and extend downward along the sidewall 18 of outer container 12. Rim 82 extends downward along the sidewall 18 of outer container 12 in a similar manner to sidewall 28 of cap member 24. Sidewall 28 of cap member 24 is now generally coextensive with cap portion 32 and rim 82 of closure 16. Rim 82 provides additional sealing on the outside of outer container 12 thereby providing more robust sealing between closure 16 and the open end 20 of outer container 12.

While several embodiments of a fluid sample collection device and method were described in the foregoing detailed description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are embraced within their scope.

What is claimed is:

1. A device for collecting and separating a fluid sample comprising:
an evacuated outer container having a first open end and a second closed end with a pierceable closure closing the first open end and defining a first interior chamber therein; and
an inner container contained within the outer container and separating the first interior chamber into an upper chamber portion in fluid communication with a lower chamber portion, the inner container defining a second interior chamber separated from the lower chamber portion of the first interior chamber through a porous membrane and including a port adapted to place the second interior chamber in fluid communication with the first interior chamber.

2. A device as claimed in claim 1, wherein the porous membrane comprises filter paper.

3. A device as claimed in claim 1, wherein the porous membrane has a pore size that controls the passing of desired molecules.

4. A device as claimed in claim 3, wherein the porous membrane prevents molecules of 60,000 Daltons or higher from passing into the inner container.

5. A device as claimed in claim 3, wherein the porous membrane is capable of removing albumin, immunoglobulin or other large molecules from a blood sample.

6. A device as claimed in claim 3, wherein the porous membrane prevents molecules of 10,000 Daltons or higher from passing into the inner container.

7. A device as claimed in claim 6, wherein the porous membrane prevents molecules of 2,000 Daltons or higher from passing into the inner container.

8. A device as claimed in claim 3, wherein the porous membrane has a pore size to enable peptide extraction from a blood sample.

9. A device as claimed in claim 3, wherein the porous membrane has a pore size to enable separation of metabolites and other small molecules from a blood sample.

10. A device as claimed in claim 1, wherein the pore size of the porous membrane is between 0.1 μm to 2 μm.

11. A device as claimed in claim 10, wherein the porous membrane is a 0.22 μm membrane.

12. A device as claimed in claim 10, wherein the porous membrane enables removal of virus particles for bio-safety plasma or serum sample collection.

13. A device as claimed in claim 10, wherein the porous membrane is a 0.45-1.0 μm membrane.

14. A device as claimed in claim 10, wherein the porous membrane enables platelet-free plasma or serum sample collection.

15. A device as claimed in claim 1, wherein the inner container is suspended within the outer container.

16. A device as claimed in claim 1, wherein the inner container is releasably connected with the pierceable closure.

17. A device as claimed in claim 16, wherein release of the inner container from the pierceable closure opens the port of the inner container and places the second interior chamber of the inner container in fluid communication with the first interior chamber.

18. A device as claimed in claim 1, wherein the inner container is movably supported within the first interior chamber of the outer container.

19. A device as claimed in claim 18, wherein movement of the inner container within the first interior chamber opens the port of the inner container and places the second interior chamber of the inner container in fluid communication with the first interior chamber.

20. A device as claimed in claim 19, wherein the outer container comprises structure therein to support the inner container within the first interior chamber after movement of the inner container within the first interior chamber.

21. A device as claimed in claim 1, wherein the outer container supports the inner container within the first interior chamber.

22. A device as claimed in claim 1, wherein the outer container comprises an additive selected from the group consisting of agglutinating agents and anticoagulants.

23. A device as claimed in claim 1, wherein the porous membrane comprises a material selected from the group consisting of high density polyethylene, high density polypropylene, ceramic, porous metal, porous glass, glass fibers, polyvinyl polymers, paper, natural fibers, and combinations thereof.

24. A device for separating plasma or serum from a blood sample comprising:
an evacuated collection assembly comprising an outer container and an inner container;
the outer container including a pierceable closure at one end; and
the inner container contained within the outer container, the interior of the inner container separated from the outer container by a porous membrane on the bottom of the inner container, and the inner container comprising a port in fluid communication with the inner container and the inner container releasably connected to the pierceable closure.

25. The device as claimed in claim 24, wherein the inner container is entirely accommodated within the outer container.

26. The device as claimed in claim 24, wherein the port is in fluid communication with the outer container when the inner container is disconnected from the pierceable closure.

27. The device as claimed in claim 24, wherein release of the inner container from the pierceable closure opens the port to unrestricted fluid communication with the outer container.

28. The device as claimed in claim 24, further comprising structure on the inner surface of the outer container for maintaining a position of the inner container relative to the outer container.

29. The device as claimed in claim 24, wherein a pressure differential established between the outer container and the inner container upon entry of the blood sample into the outer container facilitates transportation of plasma or serum through the porous membrane into the inner container, while preventing the transfer of blood cells therethrough

30. A method for separating plasma or serum from a blood sample comprising the steps of:
providing an evacuated collection assembly comprising an outer container having a pierceable closure at one end, an inner container contained within the outer container and defining an interior chamber therein, and a porous membrane separating the interior chamber of the inner container from the outer container; and
collecting a blood sample within the outer container of the assembly, thereby creating a pressure differential between the outer container and the inner container, the pressure differential causing plasma or serum from the blood sample to flow into the interior chamber of the inner container through the porous membrane.

31. The method of claim 30, wherein the plasma or serum flows into the inner container in a direction generally opposite to the direction of blood particle flow into the outer container during the collecting.

32. The method of claim 30, wherein the plasma or serum is removable from the inner container after the blood sample collection is complete.

33. The method of claim 30, wherein the inner container comprises a port, and the method further comprises placing the port in fluid communication with the interior chamber of the outer container.
